(19) United States
(12) Patent Application Publication
(10) Pub. No.: US 2011/0132148 A1
(43) Pub. Date: Jun. 9, 2011

(54) NUT SCREWING DEVICE

(76) Inventor: Lorenz Stoger, Geretsried (DE)

(21) Appl. No.: 12/632,456

(22) Filed: Dec. 7, 2009

(51) Int. Cl. B25B 21/00; B25B 23/08

(52) U.S. Cl. 81/55

(57) ABSTRACT

A nut screwing device for screwing a nut onto a rivet which is provided on the end opposite the rivet head with a blind hole having a contour that is not round in cross-section, comprising at least one drive which is drivingly connected via a transmission to a screw-in tool that has an accommodating opening for inserting the nut, characterized in that the nut screwing device comprises an anti-rotation means having a chamber in which an anti-rotation element (bit) is movably arranged that has a head section, which substantially fills the cross-section of the chamber, a shaft section, and an adjoining end section with a contour identical with that of the blind hole, the chamber being arranged adjacent the screw-in tool and comprising a central exit opening for the shaft with the end section of the anti-rotation element and being provided on the edge of the exit opening with a surrounding shoulder as a stop for the head section of the anti-rotation element (bit).

### FIELD OF THE INVENTION

The present invention relates to a nut screwing device for screwing a nut onto a rivet which is provided on the end opposite the rivet head with a blind hole having a contour that is not round in cross-section, the device comprising at least one drive which is drivingly connected via a transmission to a screw-in tool that has an accommodating opening for inserting the nut.

### SUMMARY OF THE INVENTION

It is the object of the present invention to provide a nut screwing device of the type under consideration, in the case of which it is ensured that the nuts are screwed onto the rivets in a perfect way.

This object is achieved by a nut screwing device for screwing a nut onto a rivet which is provided on the end opposite the rivet head with a blind hole having a contour that is not round in cross-section, comprising at least one drive which is drivingly connected via a transmission to a screw-in tool that has an accommodating opening for inserting the nut, and an anti-rotation means. The anti-rotation means comprises a chamber in which an anti-rotation element is movably arranged that has a head section, which substantially fills the cross-section of the chamber, a shaft section, and an adjoining end section with a contour matching the blind hole. The chamber is arranged adjacent the screw-in tool and comprises a central exit opening for the shaft with the end section of the anti-rotation element and is provided on the edge of the exit opening with a surrounding shoulder as a stop for the head section of the anti-rotation element. Further advantageous features of the design are described below.

The invention provides that the nut screwing device comprises, in its housing, an anti-rotation means having a chamber in which an anti-rotation element (bit) is movably arranged that has a head section, which substantially fills the cross-section of the chamber (i.e. the head section of the bit and the inner wall of the chamber have left thereinbetween only the minimal distance that is needed for a free movability of the bit), a shaft section, and an adjoining end section with a contour matching the blind hole of the rivet, e.g. in the form of a hexagon, and that the chamber is arranged adjacent the screw-in tool, which is preferably formed by a socket, and comprises a central exit opening for the end section and the shaft of the anti-rotation element, with a surrounding shoulder being formed on the edge of the exit opening as a stop for the head section of the non-rotation element so as to define the range of movement of the anti-rotation element. The anti-rotation element is non-rotationally held with respect to the chamber in that the head section preferably has a cross-sectional shape that is not round, e.g. the shape of a triangle with rounded edges, the circumferential wall of the chamber being formed accordingly.

When the anti-rotation element engages with its end section into the blind hole of the rivet and the chamber holding the anti-rotation element is non-rotatingly held in the nut screwing device, the screw-in tool can screw the nut correctly onto the shaft of the rivet because the latter is fixed and secured against rotation.

It is advantageously suggested that the chamber is provided on the end facing away from the screw-in tool with a wall in which an air channel terminates that is connected to a source of compressed air. The air channel can here also terminate in the upper end of the circumferential wall of the chamber, the arrangement being chosen such that the compressed air is introduced between the head section of the anti-rotation element and the rear chamber wall so as to advance the anti-rotation element into the chamber. An air sucking operation was performed by the air channel before in order to suck the anti-rotation element against the rear chamber wall, and the nut was inserted into the screw-in tool and is held in said position preferably by spring-actuated retainers. In this state the nut screwing device is preferably moved by means of a robot to the rivet inserted into the associated bore of a component.

With great advantage it is further provided that a second air channel is formed in the circumferential wall of the chamber and has an entry opening for compressed air inside the chamber, the rear edge of which has a distance from the surrounding shoulder that is greater than the thickness of the head section of the anti-rotation element and is equal to or smaller than the thickness of the head section plus the length of the end section of the anti-rotation element that is entering into the blind hole when the anti-rotation element and the blind hole are in a matching circumferential position.

The second air channel expediently comprises an exit opening that is open towards the screw-in tool.

Prior to the screwing operation compressed air flows in the air channel behind the head section of the anti-rotation element, whereby said element is advanced into the chamber until the head section rests on the surrounding shoulder of the chamber. The head section passes through the entry opening to the second air channel in the circumferential wall of the chamber and releases said entry opening so that an air flow can escape through the second air channel. The amount of the escaping air is measured by a suitable measuring device in the nut screwing device and in case of identity with a predetermined measurement value it is determined that the anti-rotation element is fully extended.

Subsequently, the nut screwing device is preferably transported by a robot to the rivet, whereupon the rivet presses the anti-rotation element back as a rule because the end section of the anti-rotation element does not enter into the blind hole, but abuts on the face of the rivet. Since the anti-rotation element is pressed back into the chamber, the head section of the anti-rotation element blocks again the second air channel, whereby the air flow that has so far escaped is interrupted and the measuring device reports that the anti-rotation element has not penetrated into the blind hole of the rivet.

Thereupon the anti-rotation element is rotated with the chamber non-rotationally holding said element about the longitudinal axis, preferably to the right/left over a predetermined angular range until the anti-rotation element penetrates with its end section into the blind hole. This is detected by the measuring means when it senses the predetermined air flow into the second air channel (and out of the second air channel, respectively).

Subsequently, the chamber is non-rotatingly held with the anti-rotation element, and the screw-in tool is rotated, whereby the nut is screwed onto the shaft of the rivet. The anti-rotation element is here pushed back. In this process the applied torque is measured by a torque sensing device, and when the predetermined maximum torque has been reached the screwing process is completed.

In an advantageous design of the invention it is suggested that the anti-rotation element comprises a shaft conically expanding in the direction of the head section, the conical contour permitting a compensation movement in the screw-in tool, whereby a small lateral offset can be compensated. Likewise, the preferably provided conical counter-contour of the end section of the anti-rotation element makes it possible to compensate for a lateral offset. As a measure of the conical extension of said two sections, 3° to 4° are suggested.

As already mentioned above, the nut screwing device according to the invention can be fastened to the arm of a robot that moves the nut screwing device precisely to the rivets set in bores of a component, such as an aircraft body, so as to screw on the nuts. The nut screwing device, however, can also be guided and operated manually by an operator.

An electric motor is expediently used as a drive for the screw-in tool without the invention being limited thereto. Likewise, the rotational movement of the chamber that is non-rotationally holding the anti-rotation element is expediently generated by an electric motor.

### BRIEF DESCRIPTION OF THE DRAWINGS

Further details of the invention become apparent from the following description of a preferred embodiment of the nut screwing device and from the drawings, in which:

FIG. 1 is a perspective view of an embodiment of the nut screwing device;

FIG. 2 is a longitudinal section through the device;

FIG. 3 is a bottom view of the device;

FIGS. 4a, 4b show an anti-rotation element in a top view on the head section and in side views, with indication of the angles of the conical extensions;

FIG. 5 is a perspective view of the anti-rotation element; and

FIGS. 6 to 11 show the region of the screw-in tool of the nut screwing device in different stages of the screwing operation.

### DETAILED DESCRIPTION OF A PREFERRED EMBODIMENT

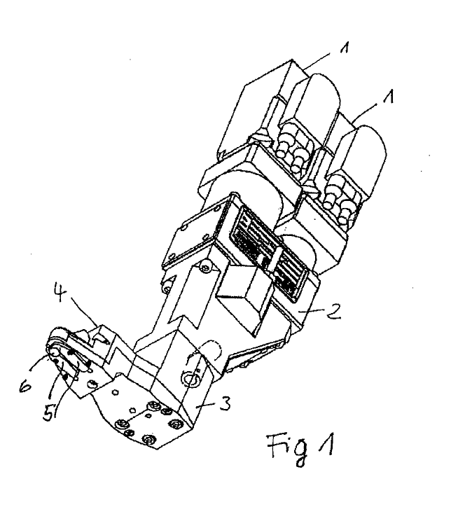

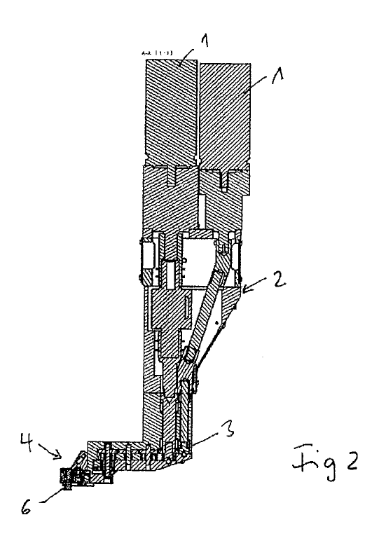

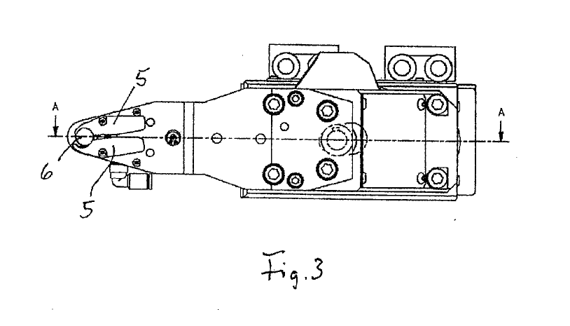

The nut screwing device shown in FIGS. 1 to 3 contains two drives 1, a housing 2, a transmission 3, and a device part 4.

The bottom side of the device has positioned on the device part 4 two spring-actuated retainers 5 holding a respectively inserted nut 6.

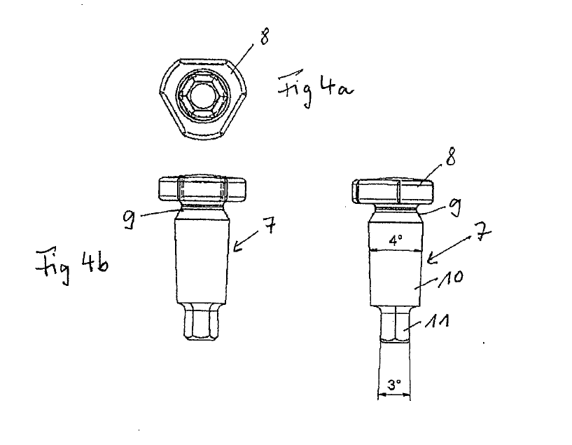

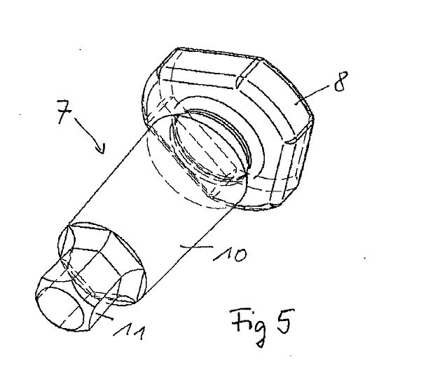

FIGS. 4a, 4b and 5 show an anti-rotation element that serves to non-rotationally hold a rivet while the associated nut is screwed on. The anti-rotation element 7 contains a head section 8 having a circumference that is not round, for example in the illustrated form of an approximated triangle with rounded edges.

A constriction 9 is followed by a shaft section 10 which has approximately a cylindrical shape, but is slightly tapered (at an angle of 4°) towards an adjoining end section 11.

When viewed in cross-section, the end section 11 has the shape of a hexagon and is enlarged towards its free end in a slightly conical way at an angle of 3°.

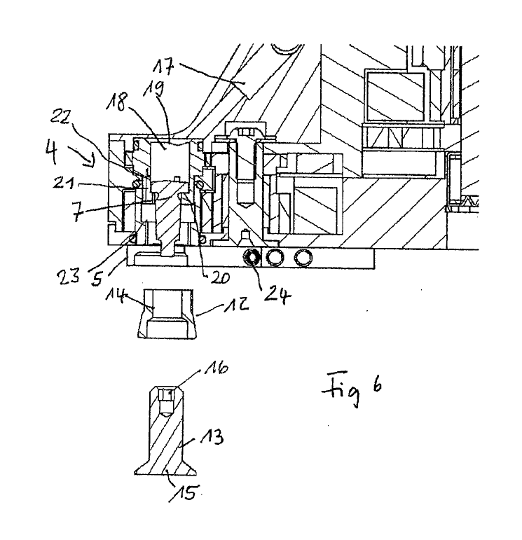

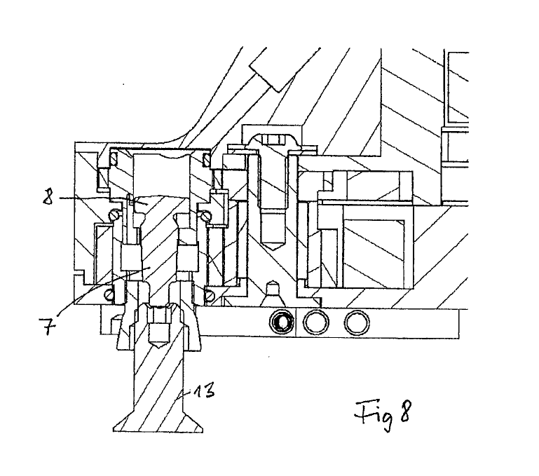

FIGS. 6 to 11 show the region of the device part 4 of the nut screwing device in different stages of the process for screwing a nut 12 onto the shaft of a rivet 13. The nut 12 is provided on the upper section 14 of its inside with a thread that must be screwed onto an external thread of the rivet 13.

At its end opposite the rivet head 15, the rivet 13 comprises a blind hole 16, the inner contour of which substantially matches the outer contour of the end section 13 of the anti-rotation element 7, i.e. the end section 11 enters into the blind hole 16 of a hexagonal cross-section with a very small lateral play when the two engagement elements are positioned in circumferential direction in a corresponding way.

An air channel 17 extends through the nut screwing device into a chamber 18 in which the anti-rotation element 7 is positioned. The chamber walls are configured such that the head section 8 of the anti-rotation element 7 tightly rests thereon within the whole range of movement of said head section 8. Since the head section 8 has a circumferential shape that is not round, it is thereby non-rotationally held in the chamber 18.

On the end opposite the upper back wall 19 the chamber 18 has a central opening the diameter of which is slightly greater than the diameter of the shaft section 10 of the anti-rotation element 7. On the edge of the central opening, the chamber 18 contains a surrounding shoulder 20 which defines the range of movement of the head section 8 of the anti-rotation element 7.

A second air channel 21 is formed in the side wall of the chamber 18 and has an entry opening 22 for the compressed air inside the chamber, the opening being positioned above the head section 8 of the anti-rotation element 7 when the head section 8 is positioned on the surrounding shoulder 20 of the chamber 18. The second air channel 21 is open towards the bottom side of the chamber 18.

Underneath the chamber 18, there is provided a screw-in tool 23 shaped as a socket into which a nut 12 is inserted prior to a screwing operation. The nut 12 is held by the above-mentioned gripper jaws 5. Reference numeral 24 designates a compression spring for the gripper jaws 5.

In the state shown in FIG. 6, compressed air flows through the air channel 17 between the rear wall 19 of the chamber 18 and the head section 8 of the anti-rotation element 7, whereby the anti-rotation element 7 is extended and rests on the annular shoulder 20. Air escapes in this position of the anti-rotation element 7 through the second air channel 21. A measuring means measures the amount of escaping air, and an evaluating means detects that the anti-rotation element has been extended up and into the end position.

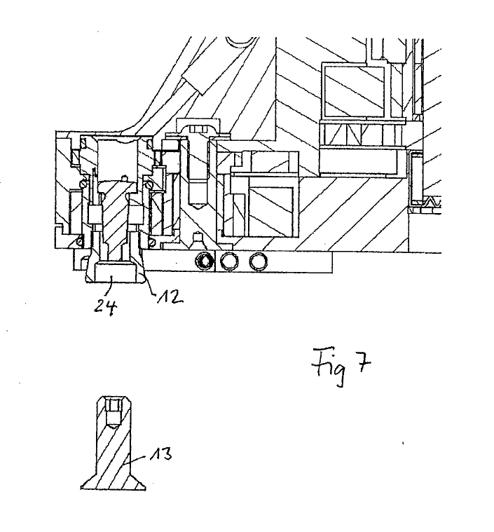

According to FIG. 7 a nut 12 is inserted into the socket of the screw-in tool 23 and held by the retainers 5.

Subsequently, the nut screwing device is moved, preferably by means of a robot, to the rivet 13 which is thereby entering (relative viewing) into the enlarged entry opening 24 of the nut and impinges with edge portions of its blind hole 16 on the end section 11 of the anti-rotation element 7, thereby pressing back said element against the air flow. The head section 8 passes in this process through the entry opening 22 of the second air channel 21, whereby the air flow is interrupted. The continuous measurement of the air flow thereby reveals that the anti-rotation element 7 with its end section 11 has not penetrated into the blind hole 16.

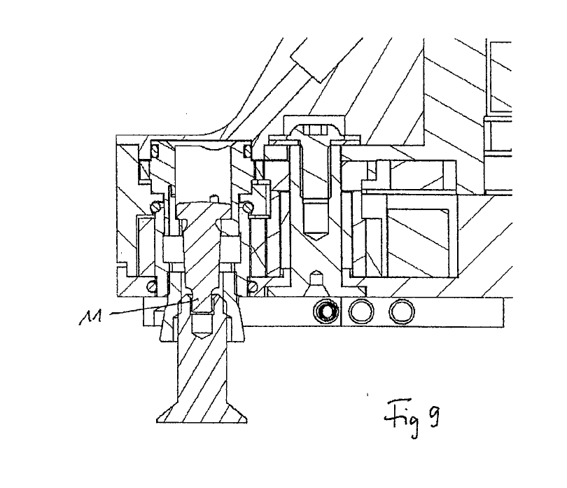

Subsequently, the anti-rotation element 7 is rotated with the housing and the chamber 18, respectively, at a predetermined angle to the right/left side until the end section 11 of the anti-rotation element 7 penetrates into the blind hole 16, pushed forwards by the air channel 17. In this state, air flows again through the air channel 21, which is sensed by the measuring means. This state is illustrated in FIG. 9.

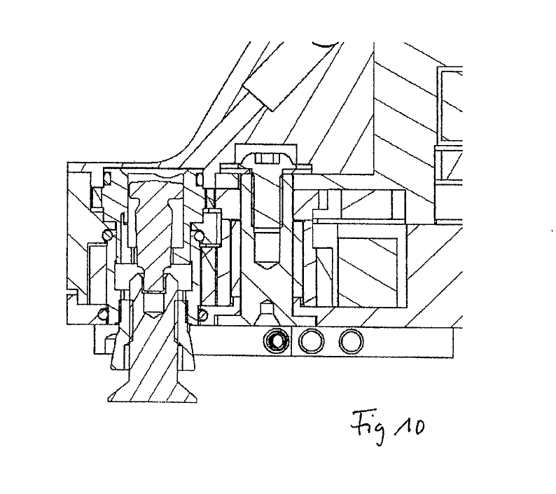

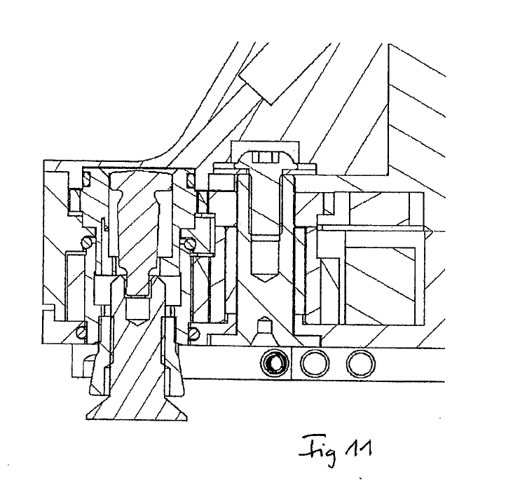

Upon a corresponding signal the screw-in tool 23 is now carrying out the screwing operation in which the anti-rotation element 7 is pressed back in the chamber 18 (FIGS. 10 and 11).

After completion of the screwing operation a negative pressure is exerted by the air channel 17 on the upper region of the chamber 18, whereby the head section 8 is sucked onto the rear wall 19.

It should be noted that the invention is not limited to the described and illustrated embodiment. All of the features disclosed in the description and in the drawing can be combined with one another individually in any reasonable way. Moreover, it should be noted that the features illustrated in the drawings, which are not described in detail, but are novel over the prior art, are claimed as pertaining to the invention.

1. A nut screwing device for screwing a nut onto a rivet which is provided on the end opposite the rivet head with a blind hole having a contour that is not round in cross-section, comprising at least one drive which is drivingly connected via a transmission to a screw-in tool that has an accommodating opening for inserting the nut, and an anti-rotation means having a chamber in which an anti-rotation element is movably arranged that has a head section, which substantially fills the cross-section of the chamber, a shaft section, and an adjoining end section with a contour matching the blind hole, the chamber being arranged adjacent the screw-in tool and comprising a central exit opening for the shaft with the end section of the anti-rotation element and being provided on the edge of the exit opening with a surrounding shoulder as a stop for the head section of the anti-rotation element; the chamber being provided on the end facing away from the screw-in tool with a rear wall in which an air channel terminates that is connected to a source of compressed air or vacuum; a second air channel being formed in the circumferential wall of the chamber and having an entry opening for compressed air inside the chamber, the edge of which is a distance from the surrounding shoulder that is greater than the thickness of the head section of the anti-rotation element and is equal to or smaller than the thickness of the head section plus the length of the part that is entering into the blind hole and belongs to the end section of the anti-rotation element; a measuring means that measures air flow in the second air channel; and the chamber being arranged with the anti-rotation element to be rotatable about its longitudinal axis.

2. (canceled)

3. (canceled)

4. The nut screwing device according to claim 1, wherein the chamber is arranged with the anti-rotation element to be rotatable about its longitudinal axis.

5. (canceled)

6. The nut screwing device according to claim 1, wherein the shaft of the anti-rotation element is conically tapered towards the end section.

7. The nut screwing device according to claim 1, wherein the end section of the anti-rotation element is conically tapered towards the shaft section.

8. The nut screwing device according to claim 1, wherein spring-actuated gripper arms in the neighborhood of the screw-in tool are arranged for holding the nut.

9. The device according to claim 1, wherein the nut screwing device is fastened to the arm of a robot.

10. A nut screwing device for screwing a nut onto a rivet, the rivet having a head on one end and a blind hole on the other end, the blind hole having a contour that is not round in cross-section, the nut screwing device comprising,
a screw-in tool configured for receiving the nut;
at least one drive which is drivingly connected via a transmission to the screw-in tool;
an anti-rotation element having a head, a shaft section and an end section, the end section configured to match the contour of the blind hole in the rivet, and a portion of the end section being configured to be received in the blind hole;
a housing having a chamber in which the anti-rotation element is received and arranged for longitudinal movement, the head section of the anti-rotation element spanning the cross-section of the chamber,
one end of the chamber adjacent the screw-in tool and having a central exit opening receptive of the shaft of the anti-rotation element,
the chamber having a shoulder adjacent the exit opening and configured as a stop for the head section of the anti-rotation element,
the chamber having an end wall opposite the one end and in which an air channel terminates,
a second air channel being formed in the circumferential wall of the chamber and having an entry opening to the interior of the chamber, the entry opening being spaced a distance from the shoulder that is greater than the thickness of the head section of the anti-rotation element and is equal to or smaller than the thickness of the head section plus the length of the blind hole receiving portion of the end section; and
an air flow measuring device connected to the second air channel.
